(19) United States
(12) Patent Application Publication
(10) Pub. No.: US 2010/0158522 A1
(43) Pub. Date: Jun. 24, 2010

(54) SEED LIGHT MODULE BASED ON SINGLE LONGITUDINAL MODE OSCILLATION LIGHT SOURCE

(76) Inventors: Seung-hyun Cho, Daejeon-si (KR); Han-hyub Lee, Daejeon-si (KR); Byoung-whi Kim, Daejeon-si (KR); Sang-soo Lee, Daejeon-si (KR); Jea-hoon Yu, Daejeon-si (KR); Jai-sang Koh, Gwangju-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/607,955

(22) Filed: Oct. 28, 2009

(30) Foreign Application Priority Data
Dec. 18, 2008 (KR) 10-2008-0129349

(51) Int. Cl. H04J 14/02; H04J 14/06; H04B 10/00

(52) U.S. Cl. 398/65; 398/79; 398/115

(57) ABSTRACT

A seed light module based on a single longitudinal mode oscillation light source is provided. The seed light module includes a multi-wavelength signal generation light source unit generating a continuous wave (CW) of different wavelengths, a multiplexer wavelength-division multiplexing the light output from the light source unit, a polarization beam splitter splitting the light of multiple wavelength components output from the multiplexer according to specific polarization components, phase modulators phase-modulating signals of a first polarization component and a second polarization component split by the polarization beam splitter onto a sine wave having a frequency and amplitude, a radio frequency (RF) signal generator generating the sine wave, a RF signal distributor distributing the generated RF signal, amplifiers amplifying the distributed RF signals, and a polarization beam combiner combining the lights phase-modulated by the respective phase modulators and providing the combined light as a seed light output.

### CROSS-REFERENCE TO RELATED APPLICATION

This application claims the benefit under 35 U.S.C. §119(a) of Korean Patent Application No. 10-2008-0129349, filed on Dec. 18, 2008, the disclosure of which is incorporated by reference in its entirety for all purposes.

### BACKGROUND

1. Field

The following description relates to a passive optical network (PON), and more particularly to a single longitudinal mode oscillation light source-based seed light module for a PON.

2. Description of the Related Art

A wavelength-division multiplexing (WDM)-PON using a reflective semiconductor optical amplifier (RSOA) as a light source of a central office (CO) or optical network terminal (ONT) can solve the problem of optical transceiver module stock from the viewpoint of a system because the RSOA is a light source having no wavelength dependency, and thus has attracted attention lately. In such a WDM-PON using a RSOA as a light source, additional seed light for wavelength selection is necessary for upstream and downstream transmission.

To implement seed light, a few methods were developed and have been applied. According to one method, wideband incoherent light generated by a high-power erbium-doped optical fiber amplifier or high-power SOA is spectrum-sliced into continuous wave (CW) light having a narrow optical bandwidth according to a WDM transmission standard. According to another method, single longitudinal mode oscillation light sources such as distributed-feedback laser diodes (DFB-LDs) are bound in the form of an array and used.

When wideband incoherent light is spectrum-sliced by a filter, etc., and used as seed light, economical implementation is enabled, seed light has no wavelength dependency, and an optical power penalty induced by back-reflection noise caused by bidirectional transmission over a single optical fiber required for PON construction is small. However, this is inappropriate for long-distance transmission because relative intensity noise increases due to spectrum slicing, seed light power decreases according to the bandwidth of a filter used for spectrum slicing, and a dispersion penalty is caused by a relatively wide optical bandwidth.

On the other hand, when a single longitudinal mode oscillation light source is used as seed light, separate light sources corresponding to respective wavelengths constituting the seed light must be prepared, that is, there is the problem of stock, and an optical power penalty is large due to back-reflection noise caused by bidirectional transmission over a single optical fiber. However, long-distance transmission is enabled by a narrow line width, a relative intensity noise is characteristic is excellent, and optical power output by each light source can be incident on an optical transmitter for generating upstream and downstream signals at a small loss.

Lately, as research on a WDM-PON appropriate for long-distance transmission is under way, a case in which a single longitudinal mode oscillation light source is used as seed light has attracted attention. When a single longitudinal mode oscillation light source is used, the main issue is economic efficiency. In this case, as mentioned above, optical power output by each light source can be used without spectral loss. Thus, a plurality of WDM-PON systems can be simultaneously administered, and the problem of economic efficiency can be partially solved.

Meanwhile, an optical power penalty induced by optical intensity noise caused by back-reflection, Rayleigh backscattering, etc., upon bidirectional transmission over a single optical fiber can be reduced using a spectrum broadening technique based on bias dithering of a RSOA used as a light source generating upstream and downstream signals or seed light itself.

However, according to the above-mentioned bias dithering technique, a dithering signal corresponding to a frequency must be applied to each of light sources constituting a seed light source. When such a driving method is used, implementation is complicated, and a controller that separately controls biases, dithering signals, etc., applied to respective light sources is required. Thus, economic efficiency is reduced.

Besides the bias dithering technique, a method using the spectrum broadening technique based on phase modulation of a CW signal for upstream/downstream transmission is lately being researched as a method of reducing an optical power penalty induced by optical intensity noise caused by back-reflection, Rayleigh backscattering, etc., upon bidirectional transmission over a single optical fiber.

However, in order to induce a spectrum broadening effect using a phase modulator, polarization of light incident on the phase modulator must be appropriately controlled. This is because most commercial phase modulators are designed to perform phase modulation on light polarized in a specific direction only. Thus, when the spectrum broadening effect is induced after respective lights output from separate light sources are polarized and incident on a phase modulator using a wavelength-division multiplexer/demultiplexer by which a polarization characteristic is maintained, the respective light sources require polarization control, as in the above-described bias dithering technique. Consequently, implementation cost increases, and the structure is complicated and difficult to manage.

### SUMMARY

The following description relates to a seed light module based on an economical single longitudinal mode oscillation light source having a simple structure. The seed light module can perform long-distance transmission because influence of optical fiber dispersion is remarkably reduced without polarization control of separate light sources, and also an optical path penalty induced by back-reflection and Rayleigh backscattering upon bidirectional transmission over a single optical fiber is reduced.

According to an exemplary aspect, there is provided A seed light module based on a single longitudinal mode oscillation light source, including: a multi-wavelength signal generation light source unit generating a continuous wave (CW) of different wavelengths; a multiplexer wavelength-division multiplexing the light output from the light source unit; a polarization beam splitter splitting the light of multiple wavelength components output from the multiplexer according to specific polarization components; phase modulators phase-modulating signals of a first polarization component and a second polarization component split by the polarization beam splitter onto a sine wave having a frequency and amplitude; a radio frequency (RF) signal generator generating the sine wave; a RF signal distributor distributing the generated RF signal; amplifiers amplifying the distributed RF signals; and a polarization beam combiner combining the lights phase-modulated by the respective phase modulators and providing the combined light as a seed light output.

The seed light module may further include an optical amplifier compensating for optical power attenuation of the light output from the polarization beam combiner and an optical distributor providing the light optically amplified by the optical amplifier to optical line terminals (OLTs).

The multi-wavelength signal generation light source unit may include separate single longitudinal mode oscillation light sources, and a laser diode capable of single longitudinal mode oscillation when current is applied is used as each of the separate light sources. The polarization beam splitter may split the light of multiple wavelength components output from the multiplexer into a horizontally polarized signal and a vertically polarized signal both corresponding to linear polarization.

The optical amplifier may be one of an erbium-doped optical fiber amplifier and a semiconductor optical amplifier (SOA).

Other objects, features and advantages will be apparent from the following description, the drawings, and the claims.

### BRIEF DESCRIPTION OF THE DRAWINGS

FIG. 1 shows a constitution of a seed light module based on a single longitudinal mode oscillation light source according to an exemplary embodiment.

FIG. 2 illustrates improvement in transmission performance when a seed light module according to an exemplary embodiment is used.

FIG. 3 is an example of a wavelength-division multiplexing (WDM)-passive optical network (PON) using the seed light module shown in FIG. 1.

FIG. 4 shows the result of a transmission test according to Rayleigh backscattering and back-reflection when a seed light module according to an exemplary embodiment is applied to a WDM-PON.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

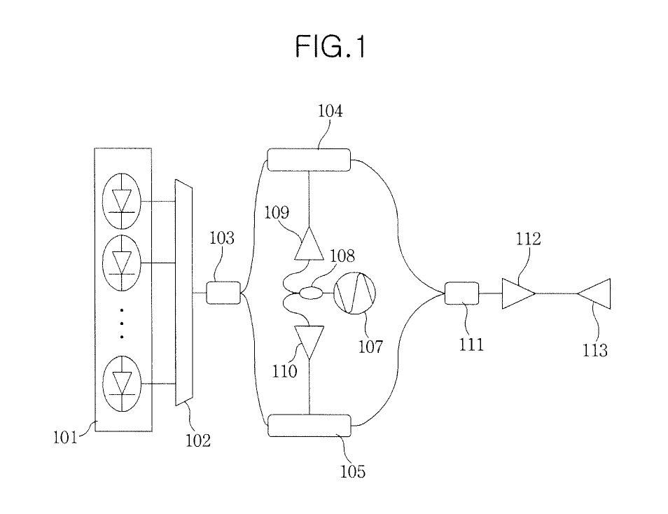

FIG. 1 shows a constitution of a seed light module based on a single longitudinal mode oscillation light source according to an exemplary embodiment.

Referring to FIG. 1, a multi-wavelength signal generation light source unit 101 is intended to generate a continuous wave (CW) of different wavelengths. The multi-wavelength signal generation light source unit 101 fundamentally includes separate single longitudinal mode oscillation light sources, and the respective light sources may be included to be appropriate for the channel capacity of a transmission system. As each of the separate light sources, a laser diode, such as a distributed-feedback laser diode (DFB-LD), external cavity laser (ECL), or distributed Bragg reflector laser diode (DBR-LD), capable of single longitudinal mode oscillation when current is applied, may be used. The separate light sources function to provide a plurality of lights that have a very narrow line width and are appropriate for long-distance transmission.

A wavelength-division multiplexer 102 multiplexes the lights output from the light source unit 101. The wavelength-division multiplexer 102 may be implemented by an arrayed waveguide grating (AWG) or arrayed thin film filter widely used in wavelength division multiplexing (WDM) transmission systems. Since the line width of the oscillation light source itself is narrow, there is no limit to the type of the filter.

A polarization beam splitter 103 splits the light of multiple wavelengths output from the multiplexer 102 according to specific polarization components. In particular, in this exemplary embodiment, the light is split into a horizontally (transverse electric (TE)) polarized signal and a vertically (transverse magnetic (TM)) polarized signal both corresponding to linear polarization.

First and second phase modulators 104 and 105 phase-modulate the signals of first and second polarization components split by the polarization beam splitter 103 onto a sine wave having a frequency and amplitude. The phase modulators 104 and 105 serve to make light of a narrow line width incident on them into light having a wide line width, a sidelobe corresponding to an applied frequency component, etc., by simultaneously phase-modulating light of multiple wavelengths corresponding to specific polarization at the frequency.

A radio frequency (RF) signal generator 107 generally generates the sine wave corresponding to a high frequency of several GHz or more. The frequency and amplitude of the generated sine wave may be changed to be appropriate to an application field.

An RF signal distributor 108 serves to distribute the signal generated by the RF signal generator 107. More specifically, in this exemplary embodiment, two paths are formed according to polarization components, and the phase modulators 104 and 105 appropriate for the respective paths are included. Thus, the phase modulators 104 and 105 must be driven by the same frequency and amplitude such that an optical spectrum having a good characteristic can be ensured. For this reason, the RF signal distributor 108 serves to equally distribute the signal output from the RF signal generator 107 to the first and second phase modulators 104 and 105.

RF amplifiers 109 and 110 amplify the distributed RF signals. Here, in order to maximize a phase-modulation-based spectrum broadening effect, the amplitude of the sine wave of the specific frequency incident on the phase modulators 104 and 105 needs to be maximized and modulated by the phase modulators 104 and 105 by an appropriate refractive index. To this end, the RF amplifiers 109 and 110 amplify the RF signals before they are incident on the phase modulators 104 and 105.

A polarization beam combiner 111 combines the lights phase-modulated by the respective phase modulators 104 and 105. In other words, the polarization beam combiner 111 serves to combine the lights that are split in two directions according to polarization and phase-modulated and provide the combined light as a seed light output of a semiconductor optical amplifier (SOA)-based WDM-PON.

An optical amplifier 112 serves to compensate for optical power attenuation of the light output from the polarization beam combiner 111. In other words, the optical amplifier 112 serves to compensate for the amount of optical power reduced by insertion loss increasing while the light travels through the phase modulators 104 and 105 and paths associated with them. The optical amplifier 112 may be an erbium-added optical fiber amplifier or high-power SOA.

Finally, an optical distributor 113 serves to provide the optically amplified light to optical line terminals (OLTs).

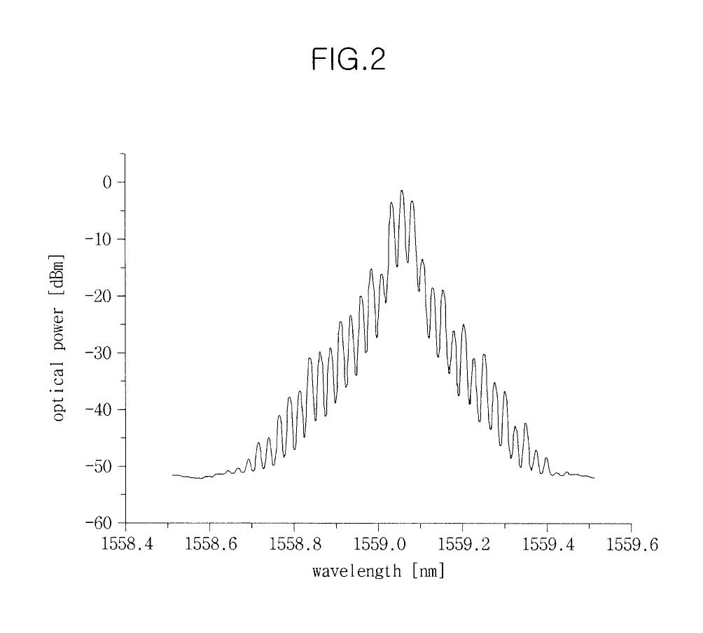

Operation of the seed light module having the above-described constitution will be described below. In the following description, FIG. 2 illustrates improvement in transmission performance when a seed light module according to an exemplary embodiment is used.

Referring to FIG. 1, light output from the multi-wavelength signal generation light source unit 101 consisting of separate light sources such as DFB-LDs has a narrow line width and polarization dependency. The light having such characteristics is multiplexed into light of multiple wavelengths by the wavelength-division multiplexer 102, and the respective multiplexed signals are incident on the polarization beam splitter 103 with their unique characteristics maintained as they are. The polarization beam splitter 103 splits the incident light into lights corresponding to two polarization states, and all the signals corresponding to the respective wavelengths are split according to a horizontal (TE) direction and a vertical (TM) direction. Lights corresponding to the respective split polarization components are incident on the respective phase modulators 104 and 105 prepared in the separate paths, and the phase modulators 104 and 105 phase-modulate the incident signals onto a sine wave signal having a frequency and amplitude. Here, the frequency of the sine wave signal may be larger than a data modulation frequency of upstream and downstream signals, and the amplitude may be as large as possible such that refractive index change is induced by sufficient modulation in the phase modulators 104 and 105 and optical spectrum broadening can be achieved. To this end, the RF signal generator 107, the RF signal distributor 108, and the RF signal amplifiers 109 and 110 are needed.

The RF signal generator 107 may be implemented by a local oscillator, etc., capable of outputting a several-GHz wave, and the RF signal distributor 108 may be implemented by a passive RF signal distributor. And, the RF signal amplifiers 109 and 110 may have as large a gain as possible such that a signal having a large amplitude to compensate for loss caused by the signal distributor 108 and achieve sufficient phase modulation can be generated. The phase modulators 104 and 105 prepared in the respective paths must be able to modulate the above-mentioned signals polarized in the horizontal direction (TE) and the vertical direction (TM). More specifically, an x-cut LiNbO₃ phase modulator may be used to phase-modulate a horizontal polarization component and a z-cut LiNbO₃ phase modulator may be used to phase-modulate a vertical polarization component.

A widened optical spectrum resulting from phase modulation of the phase modulators 104 and 105 is shown in FIG. 2. Lights that are phase-modulated in the respective paths and correspond to two polarization components are combined by the polarization beam combiner 111, and the combined light of multiple wavelength components may be used as seed light for wavelength selection of a RSOA.

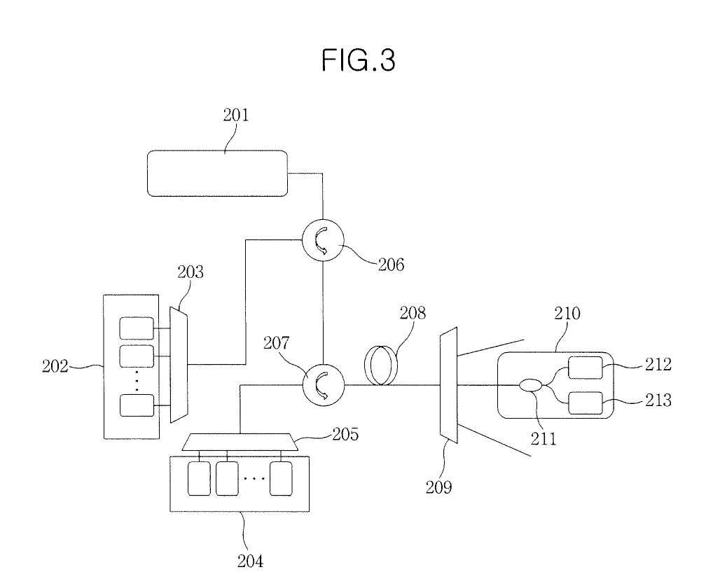

FIG. 3 is an example of a WDM-PON using the seed light module shown in FIG. 1.

Referring to FIG. 3, seed light output from a seed light module 201 according to an exemplary embodiment is incident on a RSOA-based optical transmission block 202, which is a downstream optical signal generator, via an optical circulator 206 and a wavelength-division multiplexer/demultiplexer 203 and determines a transmitted optical wavelength.

A downstream optical signal output from the optical transmission block 202 is incident on a transmission optical fiber 208 via the wavelength-division multiplexer/demultiplexer 203 and two optical circulators 206 and 207. The downstream optical signal transferred through the transmission optical fiber 208 is split according to respective wavelengths by a wavelength-division multiplexer 209 located at a remote node and then incident on each optical network unit (ONU) 210, which is a subscriber terminal. The optical signal incident on the ONU 210 is split by a 50:50 optical splitter 211. A part of the optical signal is incident on a RSOA-based optical transmission block 212, which is a light source for generating an upstream signal, and the other part of the optical signal is incident on a downstream optical signal detection block 213 and photoelectrically converted. An upstream optical signal travels in the reverse direction of the downstream optical signal. The upstream optical signal is incident on an upstream optical signal detection block 204 via the optical circulator 207 and a wavelength-division demultiplexer 205 and photoelectrically converted.

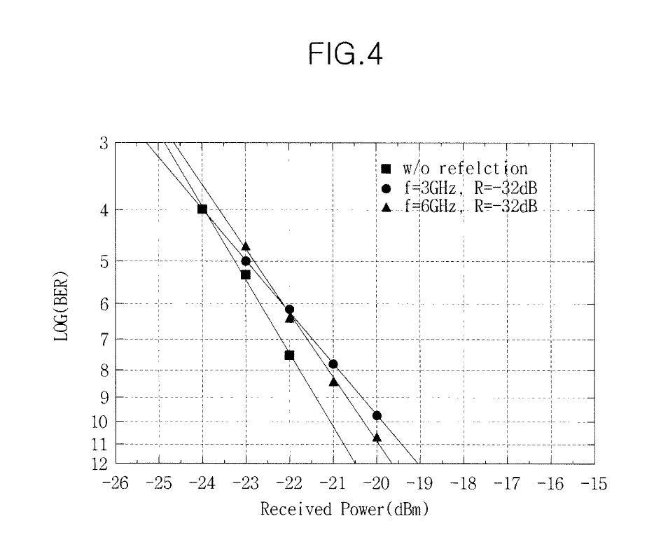

FIG. 4 shows the result of a transmission test according to Rayleigh backscattering and back-reflection when seed light according to an exemplary embodiment is applied to a WDM-PON. When an optical signal is phase-modulated onto a sine wave having a frequency of 3 GHz, it is possible to maintain an optical path penalty of about 1.5 dB compared with a case of no reflection. Needless to say, when the seed light according to an exemplary embodiment is not used, an error floor occurs in the entire section.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, the seed light module according to an exemplary embodiment can perform long-distance transmission because influence of optical fiber dispersion is remarkably reduced without polarization control of separate light sources, and also an optical path penalty induced by back-reflection and Rayleigh backscattering upon bidirectional transmission over a single optical fiber is reduced. Furthermore, since the seed light module does not require polarization control of the separate light sources, as in the bias dithering technique, it has a simple structure and is economically implemented and easily managed.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A seed light module based on a single longitudinal mode oscillation light source, comprising:
a multi-wavelength signal generation light source unit generating a continuous wave (CW) of different wavelengths;
a multiplexer wavelength-division multiplexing the light output from the light source unit;
a polarization beam splitter splitting the light of multiple wavelength components output from the multiplexer according to specific polarization components;
phase modulators phase-modulating signals of a first polarization component and a second polarization component split by the polarization beam splitter onto a sine wave having a frequency and amplitude;
a radio frequency (RF) signal generator generating the sine wave;
a RF signal distributor distributing the generated RF signal;
amplifiers amplifying the distributed RF signals; and
a polarization beam combiner combining the lights phase-modulated by the respective phase modulators and providing the combined light as a seed light output.

2. The seed light module of claim 1, wherein the multi-wavelength signal generation light source unit includes separate single longitudinal mode oscillation light sources, and a laser diode capable of single longitudinal mode oscillation when current is applied is used as each of the separate light sources.

3. The seed light module of claim 1, wherein the polarization beam splitter splits the light of multiple wavelength components output from the multiplexer into a horizontally polarized signal and a vertically polarized signal both corresponding to linear polarization.

4. The seed light module of claim 1, further comprising an optical amplifier compensating for optical power attenuation of the light output from the polarization beam combiner.

5. The seed light module of claim 4, wherein the multi-wavelength signal generation light source unit includes separate single longitudinal mode oscillation light sources, and a laser diode capable of single longitudinal mode oscillation when current is applied is used as each of the separate light sources.

6. The seed light module of claim 4, wherein the optical amplifier is one of an erbium-doped optical fiber amplifier and a semiconductor optical amplifier (SOA).

7. The seed light module of claim 4, wherein the polarization beam splitter splits the light of multiple wavelength components output from the multiplexer into a horizontally polarized signal and a vertically polarized signal both corresponding to linear polarization.

8. The seed light module of claim 4, further comprising an optical distributor providing the light optically amplified by the optical amplifier to optical line terminals (OLTs).

9. The seed light module of claim 8, wherein the multi-wavelength signal generation light source unit includes separate single longitudinal mode oscillation light sources, and a laser diode capable of single longitudinal mode oscillation when current is applied is used as each of the separate light sources.

10. The seed light module of claim 8, wherein the optical amplifier is one of an erbium-doped optical fiber amplifier and a semiconductor optical amplifier (SOA).

11. The seed light module of claim 8, wherein the polarization beam splitter splits the light of multiple wavelength components output from the multiplexer into a horizontally polarized signal and a vertically polarized signal both corresponding to linear polarization.
